(19) United States
(12) Patent Application Publication
(10) Pub. No.: US 2006/0100730 A1
(43) Pub. Date: May 11, 2006

(54) Method for detection and relocation of wafer defects

(76) Inventors: Alan S. Parkes, Lexington, MA (US); William M. Lemay, Placida, FL (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/515,697

(22) PCT Filed: Jul. 12, 2002
(86) PCT No.: PCT/US02/22016

§ 371 Date: Oct. 11, 2005

(51) Int. Cl. G06F 19/00

(52) U.S. Cl. 700/108; 438/16

(57) ABSTRACT

A method of locating and characterizing defects on semiconductor using a scanner device and a high-magnification imaging device comprises the steps of scanning (A) a test wafer a plurality of times with the scanner device, recording the scanner device coordinates of defects and the markers in the standard patterns, analyzing the coordinates to identify the standard patterns and; loading and aligning (B) the test wafer in both the average predicted coordinates and the actual coordinates for each of the located patterns, and then averaging over the multiple sets of actual coordinates; then using a non-linear least-squares program to calculate a set of alignment transformation parameters that converts the average predicted coordinates as nearly as possible to the actual coordinates.

### BACKGROUND OF THE INVENTION

During the manufacture of integrated circuits on wafers, defects often occur. These defects may consist of missing or extra patterns, or extraneous material that gets deposited on the wafer surface. These defects frequently cause the integrated circuit to malfunction, resulting in a yield of correctly performing chips that is much less than 100 percent. Determining the nature of the defects is critical to eliminating the defect sources and improving the yield of usable chips. This determination is generally accomplished by a two-step process: first, the defects are located by an optical scanner which reports their positions, then a scanning electron microscope (SEM) is used to relocate the defects and provide adequate magnification to enable identification of the nature of each defect.

Both the optical scanner and the SEM use mechanical stages to move the wafer during detection and relocation of the defects. In general, each mechanical stage is associated with an equivalent virtual stage, in which the axes are exactly linear and perpendicular, and the distances measured along each axis are correctly reported. The detection process involves the determination of the mechanical stage coordinates of a particular defect, the conversion of these coordinates to virtual stage coordinates, and the conversion of these coordinates to a coordinate system that is related to the wafer center and orientation. The relocation process involves the conversion of the reported wafer coordinates to virtual stage coordinates, then to mechanical stage coordinates, and the stage is driven to these coordinates. On each machine, the transform that enables the conversion between virtual stage coordinates and wafer coordinates is calculated by careful determination of the stage coordinates of the wafer center and the direction of the wafer flat or notch from the center.

Each of these conversions involves some error. The cumulative effect of these errors is that the SEM will not be exactly centered on the defect when it is driven to the expected position. The SEM image field of view and magnification are inversely related. The SEM magnification must be high enough so that the defect will be visible if it is in the field of view. If the defect is large enough, the SEM image magnification can be reduced to a point that the field of view is larger than the cumulative errors. If two or three defects can be located on the SEM, a second transformation can be applied to the predicted wafer coordinates that enables subsequent, smaller defects to be located at higher magnification. However, finding the first two or three defects requires operator intervention which can be quite time consuming, and, more and more frequently, there are no adequately large defects.

A qualitative analysis of these cumulative errors in defect data from a particular defect scanner, as used on a particular SEM, shows a pattern of both systematic and random components to the errors. If the predicted and actual wafer coordinates for defects are compared, a transform can be calculated, using non-linear least-squares, that corrects for differences in the assumed x- and y-coordinates of the wafer center and the rotation angle as defined by the primary orientation mark, any difference in the approximate orthogonality of the axes, and differences between the scaling factors used for the corresponding axes. If, for each stage, each axis moves in straight, parallel lines, regardless of the position of the other axis, and the reported motion for each axis is linear with the actual motion, then these six transformation parameters, hereinafter referred to as the alignment transformation parameters, will correct exactly for differences between the two stages. If these parameters are determined from defect coordinate data obtained from a single scan of a wafer, the calculated transform corrects for both the systematic errors and the particular random errors of that scan. If these alignment transformation parameters are subsequently applied to the predicted positions for defects on another wafer scanned on the same optical scanner, but with a new set of random errors, the modified predicted positions will be incorrect by the composite of the two sets of random errors.

A better procedure is to scan a wafer multiple times on a particular defect scanner, and average the resulting positions. However, defect scanners generally do not detect the exact same number of defects on successive scans, so that a comparison of predicted positions for a particular defect from several scans can be problematic at best, with a possibility of including the coordinates of another defect in the averaging.

One proposal has been to place special alignment marks on the unpatterned wafer prior to use. There would need to be at least four marks to enable determination of the alignment transformation parameters, and they would have to be small enough to have their positions determined accurately by the optical defect scanner, yet be easily locatable on the SEM. A typical design has involved a small mark centered between two larger marks for each alignment position. Chip manufacturers have been reluctant to use such wafers, and these alignment marks require operator intervention to be located on the SEM. Without any prior correction of the predicted positions, this can still be time consuming, and with the introduction of automatic defect relocation on the SEM, this is no longer feasible.

### SUMMARY OF THE INVENTION

To eliminate this problem, according to the present invention, a special test wafer is manufactured, with a pattern of features, or markers, repeated at multiple sites across the area of the wafer. After the test wafer is scanned by an optical defect scanner, a file is output that contains the predicted positions of all detected defects. Once the test wafer is scanned multiple times, the defect file for each scan can be examined. The position of the center point of the pattern at each site, if detected by pattern recognition, can be saved. The average position of the center point at each site can be calculated, along with a two-sigma radius of the scatter at that site. A composite two-sigma value for all sites and all scans can also be calculated; this composite value represents a “figure-of-merit” for the scanner. A defect file can be written reporting one “defect” for each site, with the reported position equal to the average of the positions obtained from the multiple scans at that site. This file, together with the test wafer, provides input to the SEM for obtaining actual positions of the patterns to be used in calculating the systematic error corrections. The test wafer provides features that are easy to locate in the SEM. When the center of a pattern is located with the SEM, the predicted and actual wafer coordinates can be stored to a file. Once many (˜30) coordinate sets have been stored, the file can be used as input to a non-linear least-squares program that calculates a set of alignment transformation parameters that, when used to modify the predicted positions, provides the closest agreement to the positions observed on the SEM. These alignment parameters are stored, then used to modify the predicted positions of defects detected on production wafers subsequently scanned on the same optical scanner prior to examination on the same SEM.

Briefly, according to the present invention, there is provided a method of locating and characterizing defects on semiconductor wafers using a scanner device and a high-magnification imaging device. The method comprises the steps of:
a) using a special test wafer with a standard pattern of markers at multiple sites distributed over the area of the wafer;
b) scanning the special test wafer a plurality of times with the scanner device, with the wafer loaded into the scanner, aligned, scanned and unloaded each time, recording the scanner device coordinates of all detected defects, including the markers in the standard patterns, and storing the coordinate data in files using the standard defect file format appropriate to the scanner;
c) analyzing the scanner device coordinates recorded on files in step b) to identify the standard patterns and to obtain the coordinates of the standard patterns at each site for each scan, then calculating and recording the average coordinates for each site, and storing this average position for each site in a new file in the same defect file format;
d) loading the special test wafer and this new defect file into the SEM, locating many (˜30) of the standard patterns, and storing to a file the average predicted wafer coordinates of the marker at that site, as well as the location in the SEM where the marker is found, converted to wafer coordinates;
e) using a non-linear least-squares program to calculate the particular set of alignment transformation parameters that, when applied to the average predicted coordinates, gives the best fit to the actual coordinates measured on the SEM and saving this parameter set to a file;
f) scanning a production wafer on a defect scanner to produce an output defect file of predicted positions of defects; and
g) loading the production wafer and defect file into the SEM, at which point the SEM software program will select from the table of alignment transformation parameters the set appropriate to that scanner and correct the predicted positions for the defects, without any operator intervention, such that the errors in these corrected coordinates will be mostly just the random errors of the scanner on that scan.

Preferably, the test wafer has at least 40 standard patterns of markers uniformly spaced over the test wafer. According to one embodiment of the present invention, each standard pattern of markers on the test wafer is centered on grid points that are uniformly spaced from each other in a rectangular array. The points may be spaced, for example, between 10 and 30 mm apart arranged in a rectangular grid. The markers comprising the standard patterns may be spaced between 10 and 40 microns apart with one marker in each pattern of markers being at least 20 microns wide.

Most preferably, the test wafer is unloaded and reloaded between each of the plurality of scans for recording the device coordinates of scans, and the test wafer is scanned at least 10 times before analyzing to obtain average coordinates.

Preferably, the recorded average coordinates are used with the test wafer to find the defects to be analyzed by the high-magnification imaging device.

Briefly, according to the present invention, there is also provided a method of characterizing scanning devices used for locating defects on semiconductor wafers. The method comprises the steps of:
a) using a test wafer with a standard pattern of markers distributed over the area of the wafer;
b) scanning the test wafer a plurality of times with the scanner device, recording the wafer coordinates of all detected defects, including the markers in the standard patterns;
c) analyzing the scanner device coordinates obtained in step b) to identify the standard patterns and to obtain the coordinates of the standard patterns; and
d) calculating a measure of the scatter, from scan to scan, of the predicted coordinates for the center of the pattern at each site, as compared to the average value for that site.

Most preferably, the measures of scatter over all sites are combined, to give a composite value. This is reported as a two-sigma radius, such that 95 percent of the predicted values lie within a circle of that radius. This value becomes a “figure-of-merit” for that scanner, measuring how reproducible the scanner is in determining the positions of defects.

### BRIEF DESCRIPTION OF THE DRAWINGS

Further features and other objects and advantages will become clear from the following detailed description made with reference to the drawings in which:

FIG. 1 is a schematic diagram illustrating the general process according to the present invention; and

FIGS. 2-8 are representations of various displays of a graphical user interface to a computer program useful for scanning the test wafer and analyzing the scanner according to the present invention;

FIG. 9 illustrates an acceptable pattern of markers in a standard pattern; and

FIGS. 10-15 are representations of various displays of a graphical user interface for a program for calculation of alignment transformations.

### DESCRIPTION OF THE PREFERRED EMBODIMENTS

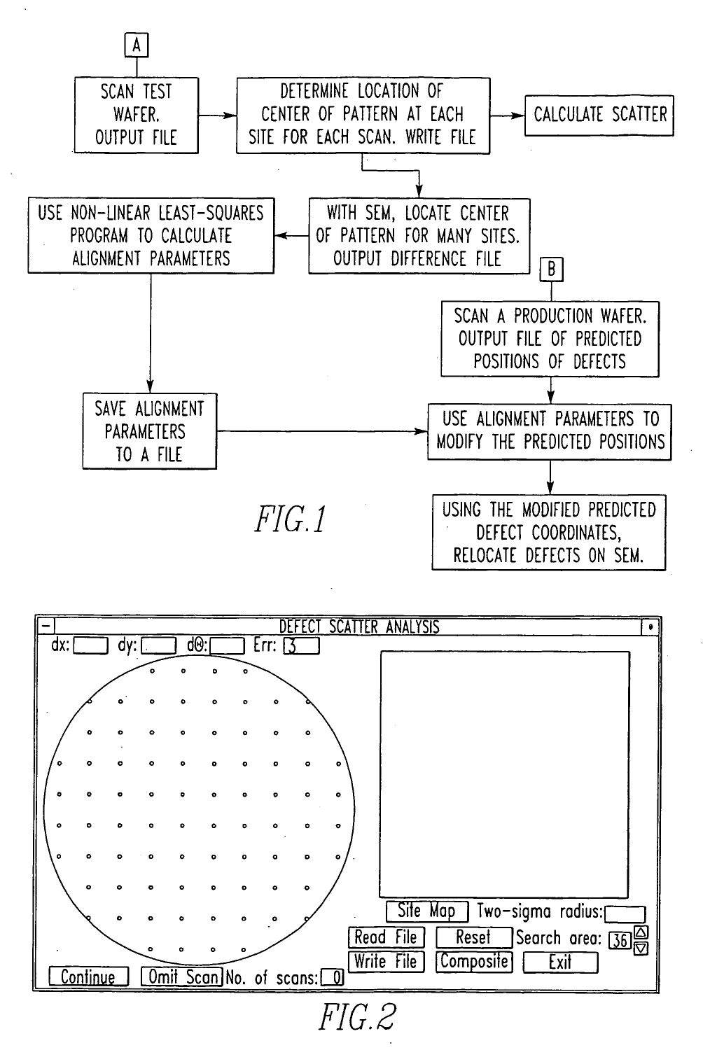

Referring now to FIG. 1, the method according to the present invention involves five basic steps: 1) A special test wafer with a pattern of markers repeated at many sites is scanned multiple times with a defect scanner. For each scan, the wafer is loaded, aligned, scanned, and unloaded and a defect file containing the coordinates of all defects detected during the scan is saved; 2) Each file is analyzed, using pattern recognition techniques to locate the center point of the pattern at each site, and these positions are stored. After all files have been analyzed, an average position for the center of the pattern is calculated for each site. A defect file is written listing just the average position for each site. These are referred to as “predicted” coordinates; 3) This defect file and the test wafer are loaded in an SEM, and “actual” coordinates of the centers of many of the pattern sites are determined. A file is generated that contains the predicted and actual coordinates of the pattern center for each of these sites; 4) These predicted and actual coordinates are analyzed to calculate, by non-linear least-squares, the alignment transformation that, when applied to the predicted coordinates, gives a best fit to the actual coordinates. These alignment parameters are saved; and 5) When a production wafer is scanned on the same defect scanner, and the wafer and the defect file are then loaded in the SEM, the predicted coordinates are automatically modified by the alignment parameters.

The method according to the present invention makes use of a special test wafer having a pattern of features, or markers, at multiple sites across the wafer. The markers can consist of raised or etched areas of any composition on the substrate; the only requirements for the markers are a) they be observable with both optical scanners and SEMs, b) some of the markers must be of sufficient size so that the optical scanner will give an accurate report of the position of the entire marker (rather than, e.g., a corner of the marker, or an agglomeration of several markers), c) the patterns must be easily visible in the SEM at a relatively low magnification, and d) the patterns must not be easily erased by routine cleaning of the wafer. It simplifies the design of the pattern recognition algorithm (and the speed of execution) if the pattern has the same orientation at each site, and it simplifies the manual relocation of the patterns in the SEM if the sites are arranged in a rectangular grid, but these are not essential requirements. The design of the pattern in this instance is shown in FIG. 9; the location of the pattern is defined as the location of the central point of the pattern. The large octagon at the left helps in manual relocation of the pattern in an SEM. The general method is applicable to any size and shape substrate; but the particular implementation described here involves circular wafers with standard diameters (4″, 5″, 6″, 8″, 12″, etc.); the wafers used for this work were 8″ (200 mm) in diameter. The arrangement of the patterns on the wafer uses a square grid of 20 mm by 20 mm; the center of the wafer is symmetrically centered among four grid points. In this arrangement, there are eighty sites on the 8″ wafer.

The first step of the method according to the present invention is to scan the test wafer with a device that detects defects or imperfections on the wafer surface, and generates a file that contains the coordinates of all detected objects. This process is to be repeated multiple times, doing between scans whatever is necessary to ensure that the expected random alignment errors are the same for all loads. Typically, this means unloading the wafer to a cassette, then reloading and realigning, but it might entail changing the orientation of the wafer once in the cassette. It may be necessary to ‘tune’ the defect scanner so that it is sensitive to the size range of the small markers in the pattern so that the reported defects include the markers.

Partly because of the random alignment errors of the scanner, the reported defect coordinates will not be exact, that is, they will be based on a coordinate system that is not exactly coincident with the wafer coordinate system. The random errors can be minimized by averaging multiple scans of the test wafer. The systematic errors are substantially eliminated by the calculation of the alignment transformations described herein. However, when a production wafer is scanned, there is no effective way to combine multiple scans so that the predicted coordinates cannot be better than the particular set of random errors made during that scan.

The next step according to the present invention is to extract from the several scans of the test wafer the coordinates of the center point of each pattern at each site. A computer program with a graphical user interface has been developed by the Applicant to assist in this comparison. The user interface of this program is illustrated in FIG. 2. On the left side of the user interface is a frame in which a wafer map is displayed along with representations of grid points. On the right side of the display is a frame for displaying either a site map or a scatter plot. Along the top left of the display are four text boxes labeled “dx:”; “dy:”; “dθ:”; and “Err:”. The first three text boxes are used to input shift and rotation values to modify all of the coordinates in the input defect file. The “Err” parameter sets the allowable error relative to an adjacent defect when performing pattern recognition. The default value is ±3 microns. On the lower right is a text box with two arrow buttons for adjusting the size of the search area around each of the grid points when looking for a match to the standard pattern. The value can be changed from 36 mm² (a 6 mm by 6 mm box centered on the site position) to 1, 4, 9, 16, 25, 49, 64, or 400 mm². Only those defects that fall within the search area surrounding a grid point are checked for a match to the pattern of markers. A number of command buttons are also located on the user interface and will be referred to hereafter.

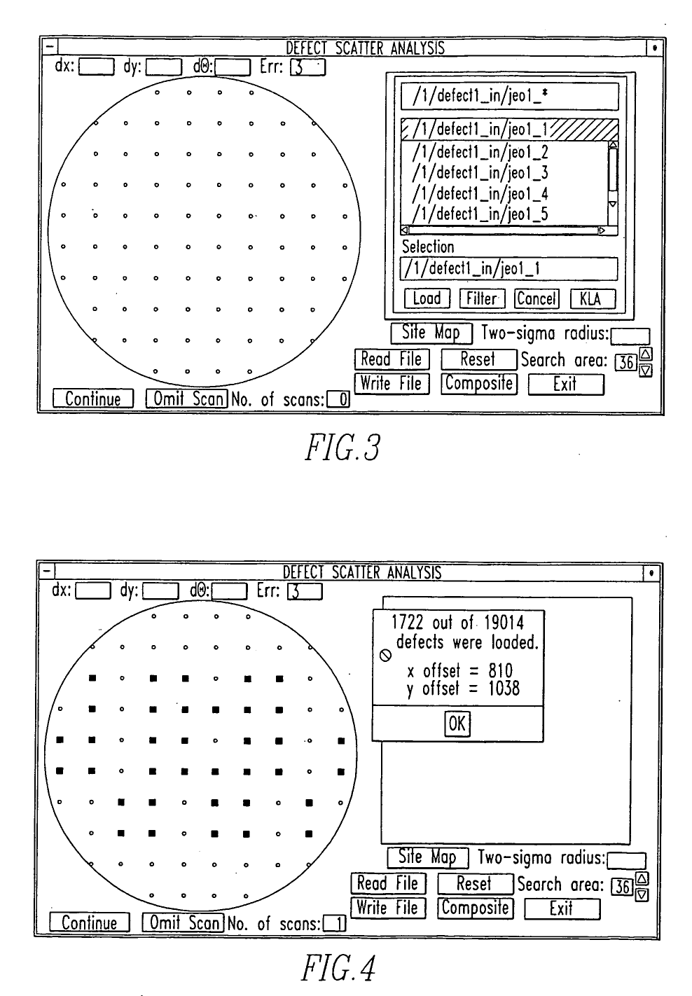

To begin the matching process, the button labeled “Read File” is selected with a mouse click. The interface changes as shown in FIG. 3, permitting the selection of one of the defect files created when the test wafer was scanned. The file is now read. The file is parsed for the first set of reported defect positions and the position of each defect is checked to see if it falls within the search areas surrounding each of the grid points corresponding to the layout of the test wafer. Any defect that falls within a particular area is assigned to that site. Each site is then studied to see if some of the defects assigned to it form a pattern that matches the standard pattern of defects. If there is a match for that site, the corresponding grid point on the wafer map is painted as shown in FIG. 4. A message box will show how many defects were in the defect file and how many were assigned to sites. The number assigned to sites will be less than the total unless the 400 mm² search area is selected, in which case all points will be included.

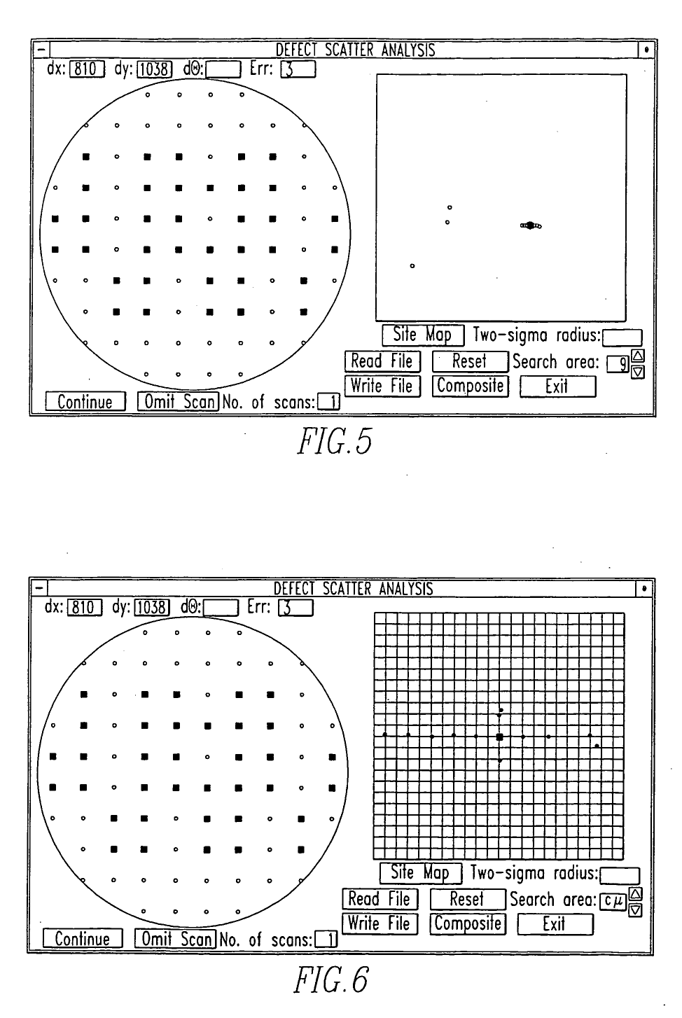

The defects at any site may be observed by clicking the mouse on the grid point on the wafer map; the defects assigned to the site associated with that point are displayed on the site map. If the standard pattern of markers has been located, the center point of the pattern will be marked in red, as shown in FIG. 5. The “Search Area” arrow buttons can be used to change the magnification of the site map. In addition, the down arrow button can be used to select values of the “Search Area” below 1, namely, μ and cμ. The cμ setting shows a field of about 220×220 microns with grid lines every 10 microns. If the defects matching the standard pattern are close to the grid point, they will be shown. If cμ is selected, the same field is shown but the center of the grid is made coincident with the center of the matched pattern, as shown in FIG. 6. If no pattern match was obtained for that site, the map will be centered on the grid point.

For the first scan of the input file, the average x and y offsets are also displayed. If “Omit Scan” is selected and the average offsets are entered in the “dx:” and “dy:” text boxes, the scan can be repeated with these offsets used to modify the coordinates of each defect location prior to the assignment of defects to sites during the pattern matching procedure. The search area can then be reduced.

If the site map shows that the pattern matching routine has incorrectly identified the pattern position at the site, click the mouse on the site map. The marker dot on the wafer map for that site will be removed and the results for that site and scan will be changed accordingly.

If the defect file contains data from several scans, “Continue” can be used to examine the next defect set in the file. If the file does not have any more defect data, “Read File” will enable selection of another file from the same set of scans (all relating to the same scanning device). The defect data will be read and processed in the same way. Each time a data set is processed, the scan count display near the bottom of the graphic interface is incremented. If the results of any scan are not satisfactory, “Omit Scan” can be selected to eliminate the most recent scan. To start the scans over, “Reset” can be selected.

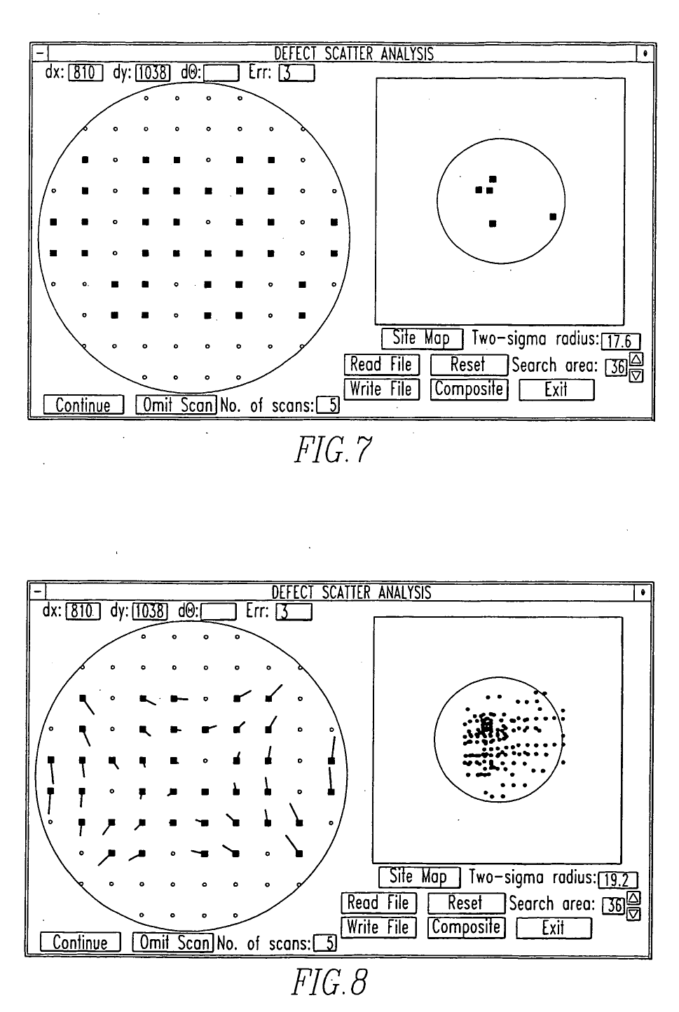

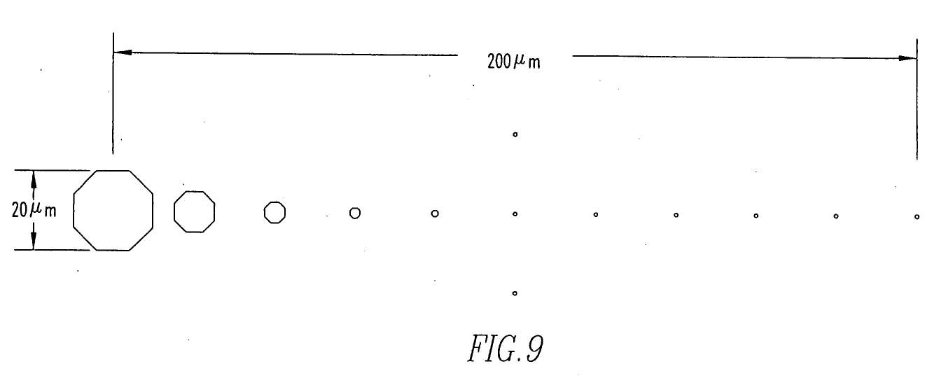

Once two or more scans have been completed, “Site Map” becomes sensitive. A mouse click will change it to a “Scatter Plot”. Clicking on a grid point on the wafer map will cause a plot to be drawn showing the position of the center point of the pattern for each scan at that site. The plot will be centered at the average position of the center point for that site and the scale adjusted to display the two-sigma radius as a circle on the plot, as shown in FIG. 7. The numerical length of the two-sigma radius is displayed in the “Two-Sigma Radius” text box.

When “Scatter Plot” is selected, “Composite” may then be selected to display the pattern positions for all scans and all sites, as shown in FIG. 8. The plot for each site is centered at the average pattern position for that site, and the two-sigma radius is calculated for all detected patterns. The composite two-sigma radius represents a figure-of-merit for the random scatter in the reported defect positions for the particular scanner. A window (not shown in FIG. 8) will show the average displacement of each detected standard pattern from its grid point averaged over all sites and scans. The wafer map is also redrawn, with vectors showing the displacement from the grid point for that site. Note that this plot is based upon the input defect positions after adjusting with any dx, dy or dθ offset values. To the extent that averaging over the multiple scans has minimized the random errors in the averaged predicted coordinates, these vectors, plus the offset values, show the systematic errors that the scanner makes when reporting defect positions, assuming that the test wafer is as designed. These systematic errors, plus wafer layout errors, plus any SEM systematic errors, are all corrected for by applying the calculated alignment transformations.

Once a sufficient number of scans (up to 25) have been analyzed, “Write File” will generate a defect file (in the same format as the input defect file) that reports one “defect” for each of the eighty sites. If the pattern was detected at a site in one or more scans, the position for that “defect” will be the average of the detected pattern positions, with a classification equal to the number of scans in which the pattern was detected. If the pattern was never detected at a given site, the “defect” is reported at the position of the site itself, with a classification of zero.

The defect file and the wafer are now loaded into an SEM. Using the predicted positions from the file, the center of the pattern is relocated for many sites. At each of these sites, the predicted and actual wafer coordinates are written to a file. If there were significant errors in the wafer positioning in the SEM, this process could be repeated several times, again with the wafer unloaded, reloaded, and aligned each time, so that several files of predicted and actual coordinates would be written. These files could then be merged into a single file with average actual coordinates. However, SEMs, such as the JEOL JWS-7550/7555, typically have very precise wafer alignment procedures with very small random errors, so that a single load and relocation of the patterns is sufficient.

Even though this file of predicted and actual coordinates of the pattern center positions at the various sites describes the same physical points on the wafer, and both sets are expressed in purportedly the same wafer coordinate system, they will not, in general, be the same. The differences at this point represent mostly the systematic differences between the two stages. As such, these errors are repeated each time a wafer is scanned by the particular scanner, then inspected in the particular SEM. If a least-squares program can determine a transformation that modifies the predicted positions to give a better agreement to the actual positions as observed in the SEM, then the same transformation applied to subsequent predicted positions of defects, as detected by the same scanner on a production wafer, should result in corrected predicted positions that are much closer to the actual positions as examined in the same SEM. A non-linear least-squares program (lmls) can be used to calculate these transformation parameters.

Clearly, the predicted (scanner) and actual (SEM) coordinate systems may not be coincident, so there is a Δx, Δy, θ set that shifts the origin and rotates one system so the x-axes are coincident. In addition, the axes may not measure the same units, so there is a scale factor r(x′/x) between what the scanner x-axis measures and what the SEM x-axis measures, and there is a corresponding y-axis scale factor r(y′/y). Also, if the x-axes are coincident, the y-axes may not be, so a correction for this non-orthogonality difference xsh can be made. One more scale factor, the ratio of the SEM x-axis to the SEM y-axis r(x′/y′) can be applied. (If all of the axes are straight and linear, this should be sufficient, otherwise, each axis must be mapped, and if the axes interact, the mapping must be two-dimensional.)

In the lmls program, the array variables for the predicted and actual coordinates are defined as follows:

xdata [0][i]=the predicted x coordinate for the ith defect;

xdata [1][i]=the predicted y coordinate for the ith defect;

ydata [0][i]=the actual x coordinate for the ith defect; and

ydata [1][i]=the actual y coordinate for the ith defect.

(Note that the xdata array refers to both the x and y coordinates of the predicted positions; the ydata array refers to the actual x and y coordinates.)

The a[ ] array refers to the correction parameters, in this order:
[1]=Δx
[2]=Δy
[3]=θ
[4]=r(x′/x)
[5]=r(y′/y)
[6]=r(x′/y)
[7]=xsh

The residual for the ith defect (the distance between the predicted and actual position) is Rᵢ=√((ydata[0][i]−xdata [0][i])²+(ydata[1][i]−xdata[1][i])²). The correction parameters are adjusted so that, when the predicted positions are modified by these parameters, the sum of the squares of all the residuals will be minimized.

The modified xdata[0][i] (using the a correction parameters) will be x=a[1]+xdata[0][i]*a[4]*cos(a[3])−xdata[1][i]*a[5]*a[6]*sin(a[3])+xdata[1][i]*a[7]

The modified xdata[1][i] will be y=a[2]+xdata[0][i]*(a[4]/a[6])*sin(a[3])−xdata[1][i]*a[5]*cos(a[3])

The equation for the residual Rᵢ as a function of the correction parameters can now be written, and the sum of the Rᵢ² terms, X², where the summation is over all ndata pairs of predicted and actual defect coordinates, i.e., i runs from 1 to ndata, can be calculated. Using the following notation to represent the summation terms,
sy0=Σ ydata[0][i]
sy1=Σ ydata[1][i]
sx0=Σ xdata[0][i]
sx1=Σ xdata[1][i]
sy02=Σ ydata[0][i]²
sy12=Σ ydata[1][i]²
sx02=Σ xdata[0][i]²
sx12=Σ xdata[1][i]²
sy0x0=Σ (ydata[0][i]*xdata[0][i])
sy1x1=Σ (ydata[1][i]*xdata[1][i])
sy1x0=Σ (ydata[1][i]*xdata[0][i])
sy0x1=Σ (ydata[0][i]*xdata[1][i])
sx0x1=Σ (xdata[0][i]*xdata[1][i])
the equation for X² is

$${X}^{2} = + 2 * a [ 1 ] * a [ 4 ] * cos ( a [ 3 ] ) * sx 0 + 2 * a [ 2 ] * ( a [ 4 ] / a [ 6 ] ) * sin ( a [ 3 ] ) * sx 0 - 2 * a [ 1 ] * a [ 5 ] * a [ 6 ] * sin ( a [ 3 ] ) * sx 1 + 2 * a [ 1 ] * a [ 7 ] * sx 1 + 2 * a [ 2 ] * a [ 5 ] * cos ( a [ 3 ] ) * sx 1 - 2 * a [ 1 ] * sy 0 - 2 * a [ 2 ] * sy 1 + {a [ 4 ]}^{2} * cos ( {a [ 3 ]}^{2} ) * sx 02 + ( {a [ 4 ]}^{2} / {a [ 6 ]}^{2} ) * sin ( {a [ 3 ]}^{2} ) * sx 02 + {a [ 5 ]}^{2} * {a [ 6 ]}^{2} * sin ( {a [ 3 ]}^{2} ) * sx 12 - 2 * a [ 5 ] * a [ 6 ] * a [ 7 ] * sin ( a [ 3 ] ) * sx 12 + {a [ 7 ]}^{2} * sx 12 + {a [ 5 ]}^{2} * cos ( {a [ 3 ]}^{2} ) * sx 12 + sy 02 + sy 12 - 2 * a [ 4 ] * cos ( a [ 3 ] ) * sy 0 x 0 - 2 * a [ 5 ] * cos ( a [ 3 ] ) * sy 1 x 1 + 2 * a [ 5 ] * a [ 6 ] * sin ( a [ 3 ] ) * sy 0 x 1 - 2 * a [ 7 ] * sy 0 x 1 - 2 * ( a [ 4 ] / a [ 6 ] ) * sin ( a [ 3 ] ) * sy 1 x 0 - 2 * a [ 4 ] * a [ 5 ] * a [ 6 ] * cos ( a [ 3 ] ) * sin ( a [ 3 ] ) * sx 0 x 1 + 2 * a [ 4 ] * a [ 7 ] * cos ( a [ 3 ] ) * sx 0 x 1 + 2 * a [ 4 ] * ( a [ 5 ] / a [ 6 ] ) * cos ( a [ 3 ] ) * sin ( a [ 3 ] ) * sx 0 x 1 + ndata * {a [ 1 ]}^{2} + ndata * {a [ 2 ]}^{2} .$$

The next step is to find the set of correction parameters that minimizes X². Given that ndata can be much larger than 7 (the maximum number of parameters to be determined), the method of least-squares is applicable. However, since X² is not linear with respect to all of the parameters, a non-linear least-squares method is needed. Of these, the Levenberg-Marquardt method is perhaps the most robust. As in any non-linear minimization problem, an exact solution for the parameters that minimize the function cannot be written. It is necessary to proceed in steps to smaller and smaller values of the function. To do this, the Taylor series expansion of a function can be used about a point P.
ƒ(x)≡ƒ(P)+Σ∂ƒ/∂xᵢ*xᵢ+½*Σ∂²ƒ/∂xⱼ*xᵢxⱼ+ . . . .

The vector of first partial derivatives represents the slope, or gradient, of the function with respect to each of the parameters to be fit. The matrix of second partial derivatives represents the curvature, or Hessian, of the function. In “Numerical Recipes in C”, Second Edition, by Press, Teukolsky, Vetterling and Flannery, page 682, it is explained that the gradient tells us in which direction to change each parameter, but not by how much. The Hessian can be used (to some extent) to calculate the magnitude of the change. The calculations and notation in the lmls program follow those described in the reference, except that the x (predicted) and y (actual) data points are each a function of two parameters, the x and y coordinates, rather than just one parameter. The matrix inverter is the Gauss-Jordan elimination method, with full pivoting. (See ibid, page 36).

The refinement proceeds, one step at a time, until there is no significant reduction in the X² value. A last cycle calculates the standard deviations and correlation matrix. This set of alignment parameters can now be stored in a file, which can be read by any of the unpatterned defect review programs for modification of input defect coordinate data. The parameters can also be loaded into lmls, so that another points table of predicted and actual defect positions can be read and the predicted coordinates modified by the parameters.

The alignment parameters can be used with the defect file obtained by scanning a production wafer on a high-magnification imaging device, such as the JEOL JWS-7550/7555 available from the assignee of this patent application, to analyze automatically defects identified by the optical scanner. The process for finding the defects on the high-magnification imaging device is greatly facilitated. In industrial settings, a number of different optical scanning devices may scan production wafers that are then analyzed by one or more high-magnification imaging devices. Since the stage coordinates for the standard patterns on the test wafer may differ for each optical scanner, a separate set of alignment parameters is required for each optical scanner to be used with each high-magnification imaging device.

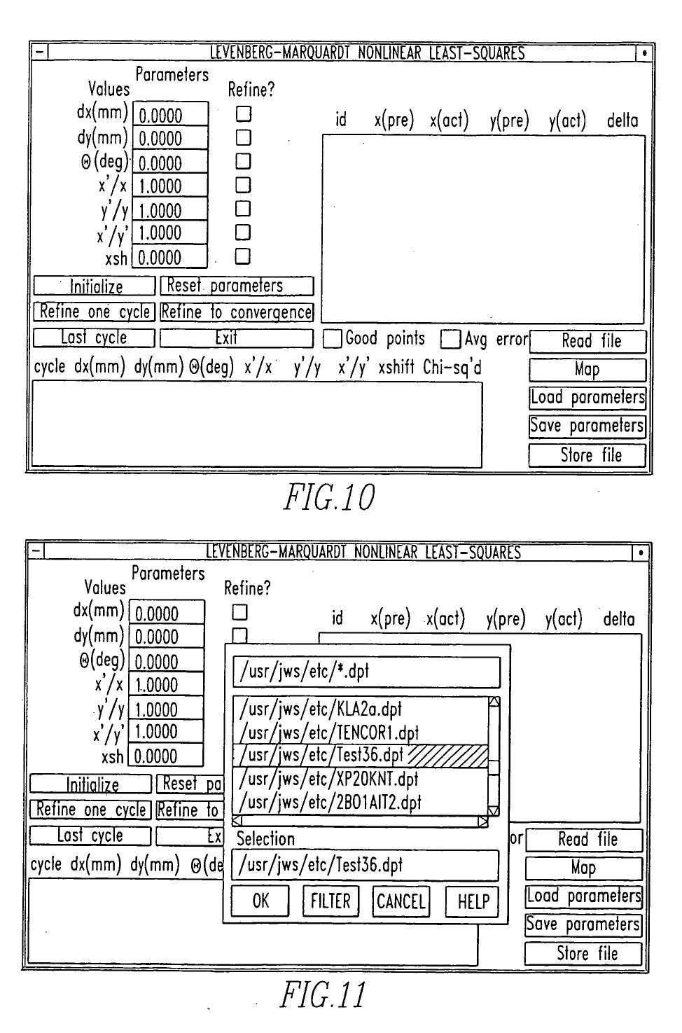

A program with a graphical interface has been developed by the applicant to implement the non-linear least-squares program (lmls). The first display when the lmls program is started is shown in FIG. 10. To begin the calculation of the alignment transformations, one mouse-clicks on “Read File” to open a file selection dialog box. (See FIG. 11). The filed to be used is selected and “OK” is clicked to load the data from the file. The predicted and actual x and y coordinates are displayed in the scrolled window in the upper right corner of the display for all of the relocated points. The displayed predicted positions have been modified by the parameters displayed in the list in the upper left corner of the display. As shown in FIG. 11, the listed default parameters do not change the predicted positions.

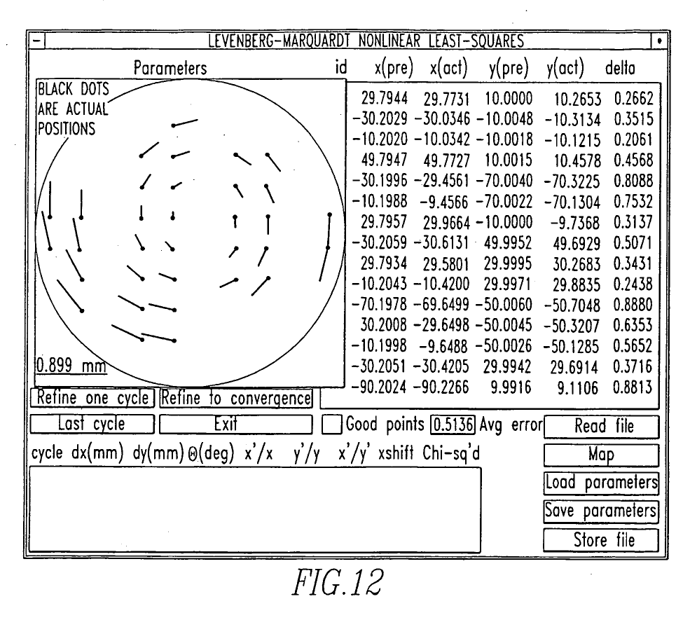

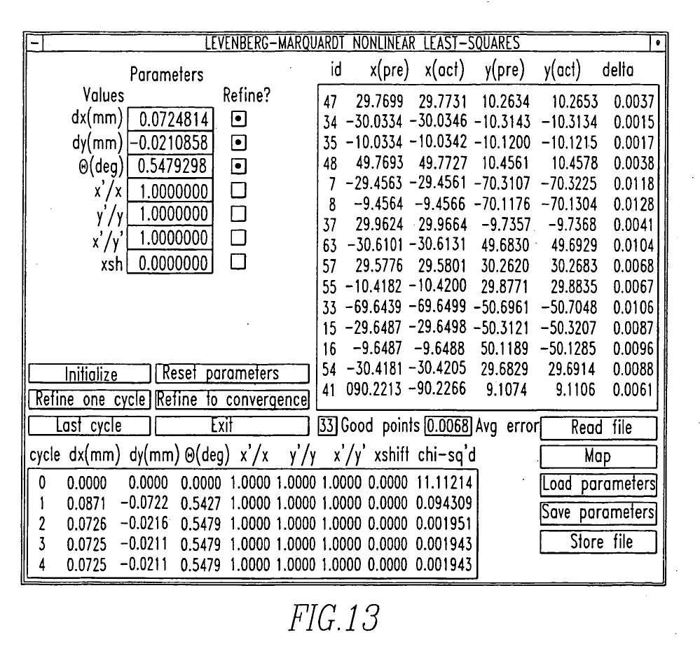

At this point, the user can click “Map” to show a plot of the wafer. (See FIG. 12). The black dots on the map represent the actual positions of the pattern at each site and the other end of the lines extending from the dots represent the predicted positions. The line lengths are proportional to the size of the difference between the actual and predicted positions. As shown in FIG. 12, the major systematic error is a rotation. Clicking on “Map” again closes the plot.

To begin refinement, select the parameters to be refined. It is often better to first refine the major parameters dx, dy, and θ. To do so, one clicks on the button to the right of each parameter to select it. To begin the refinement “Initialize” is clicked. The initialization performs a zero cycle in the refinement showing the starting values of the parameters in and the Chi-squared value to be minimized in the window at the lower left. Now “Refine to Convergence” is clicked and the refinement will proceed through several cycles until there are no significant changes in the Chi-squared value. (See FIG. 13).

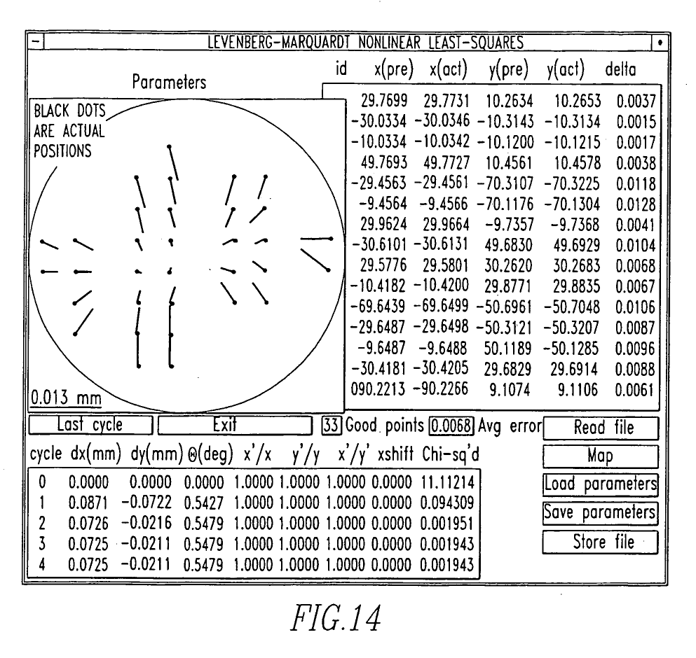

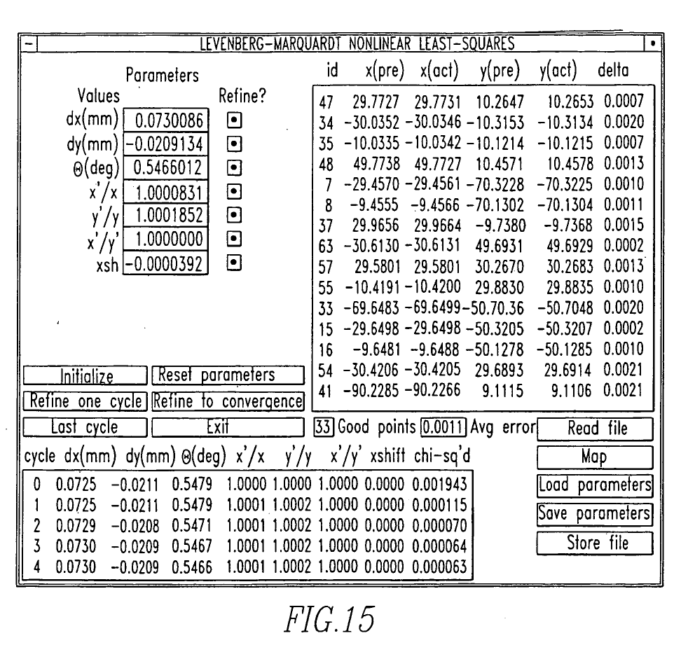

If “Map” is clicked again, it is apparent that the major errors have been removed. The scale factor differences are now clearly shown. (See FIG. 14). Note that the average error has been reduced from 513.6 microns to 6.8 microns by the refinement of the major parameters.

Now the remaining parameters (except x′/y′) are selected for refinement. The refinement then proceeds to an average error of only 1.1 microns. (See FIG. 15). By clicking “Last Cycle”, the standard errors for all refined parameters are displayed. By clicking “Save Parameters”, the alignment parameters are saved in a file that can be accessed by the defect review program when another wafer, scanned on the same scanner, is loaded in the SEM so that the predicted positions can be modified. “Load Parameters” opens that file and shows the parameter sets that have been stored.

It should be understood that, as a practical matter, a computer program is required to analyze the scanner device coordinates to identify the standard patterns and to obtain the offset coordinates of the standard patterns relative to the wafer coordinates for corresponding patterns. Such a program is easily written by those competent in the programming arts using standard pattern matching algorithms. Likewise, as a practical matter, a computer program is required to perform the non-linear least-squares analysis. Programs with graphical interfaces have been disclosed herein. Other computer programs with or without graphical user interfaces could be used to practice this invention.

Having thus described the invention in the detail and particularity required by the Patent Laws, what is desired protected by Letters Patent is set forth in the following claims.

The invention claimed is:

1. A method of locating and characterizing defects on semiconductor wafers using a scanner device and a high-magnification imaging device comprises the steps of:
a) using a test wafer with a plurality of standard patterns of markers distributed over the area of the wafer;
b) scanning the test wafer a plurality of times with the scanner device with loading, aligning, and unloading the wafer each time, recording the scanner device coordinates of defects and the markers in the standard patterns;
c) analyzing the scanner device coordinates obtained in step b) to identify the standard patterns and to obtain the coordinates of the standard patterns, and calculating and recording the average coordinates of a plurality of standard patterns;
d) loading and aligning the test wafer in an SEM, and loading the special defect file with the average predicted coordinates of the centers of the patterns, as detected by the optical scanner, then locating many of these patterns and writing to a file both the predicted and actual coordinates of the center point of each pattern; and
e) using a non-linear least-squares program that reads the file written in step d) calculating a set of alignment transformation parameters that, when used to modify the predicted coordinates, gives the best fit between these modified coordinates and the actual coordinates.

2. The method according to claim 1, wherein the test wafer has at least 40 standard patterns uniformly spaced over the test wafer.

3. The method according to claim 2, wherein each standard pattern of markers on the test wafer is centered on grid points that are uniformly spaced from each other in a rectangular array.

4. The method according to claim 3, wherein the grid points are spaced between 10 and 50 mm apart.

5. The method according to claim 4, wherein the markers in the standard patterns are arranged in two intersecting perpendicular rows sharing a common marker and include at least one marker larger than 10 microns wide.

6. The method according to claim 5, wherein the markers are spaced between 10 and 40 microns apart.

7. The method according to claim 1, wherein the test wafer is unloaded, reloaded, and realigned between the plurality of scans described in steps b) and d).

8. The method according to claim 7, wherein the test wafer is scanned at least 5 times in steps b) and d).

9. The method according to claim 1, wherein the alignment transformation parameters comprise Δx, Δy, and θ origin shift and axes rotation parameters.

10. The method according to claim 9, wherein the alignment transformation parameters comprise, in addition, at least one of an x scale factor ratio, a y scale factor ratio, a non-orthogonality factor, and an x/y scale ratio factor.

11. A method of characterizing scanning devices used for locating defects on semiconductor wafers using a scanner device comprises the steps of:
a) using a test wafer with a standard pattern of markers distributed over the area of the wafer;
b) scanning the test wafer a plurality of times with the scanner device, recording the scanner device coordinates of the markers in the standard patterns for each scan;
c) analyzing the scanner device coordinates obtained in step b) to identify the standard patterns; and
d) calculating a measure of the scatter of said coordinates.

12. A method of locating and characterizing defects on semiconductor wafers using a scanner device and a high-magnification imaging device comprises the steps of:
a) using a test wafer with a plurality of standard patterns of markers distributed over the area of the wafer;
b) scanning the test wafer a plurality of times with the scanner device, recording the scanner device coordinates of defects and the markers in the standard patterns;
c) analyzing the scanner device coordinates obtained in step b) to identify the standard patterns and to obtain the coordinates of the standard patterns, and calculating and recording the average coordinates of a plurality of standard patterns;
d) with the test wafer and the high-magnification device, recording the high-magnification device coordinates of defects and the markers in the standard patterns;
e) analyzing the high-magnification device coordinates obtained in step d) to identify standard patterns and to obtain the coordinates of the standard patterns, and calculating and recording the average coordinates of a plurality of standard patterns;
f) using a non-linear least-squares program calculating a set of alignment transformation parameters that can be used to transform scanning device coordinates to predicted high-magnification device coordinates;
g) scanning a production wafer on the scanning device and recording the coordinates of defects; and
h) using the recorded coordinates of defects for the production wafer and the alignment transformation parameters to predict the position of the defects when the production wafer is installed on the high-magnification imaging device.

13. A method of locating and characterizing defects on semi-conductor wafers using a scanning device and a high-magnification imaging device comprises the steps of:
a) scanning a production wafer on a scanning device and recording the coordinate positions of defects; and
b) using at least three transformation parameters selected from the group comprising a Δx origin shift parameter, a Δy origin shift parameter, a θ axis rotation parameter, an x scale factor ratio parameter, a y scale factor ratio parameter, an x/y scale ratio parameter, and an axis non-orthogonality parameter to transform defect coordinates recorded in step a) to predicted high-magnification imaging device coordinates.
